(19) United States
(12) Patent Application Publication
(10) Pub. No.: US 2002/0077870 A1
(43) Pub. Date: Jun. 20, 2002

(54) Method of providing insurance for intellectual property

(76) Inventor: William T. Wilkinson, Salem, NJ (US)

Correspondence Address: RATNER & PRESTIA, P.O. BOX 7228, WILMINGTON, DE, 19803, US

(21) Appl. No.: 09/982,440

(22) Filed: Oct. 18, 2001

Related U.S. Application Data
(60) Provisional application No. 60/242,307, filed on Oct. 20, 2000.

(51) Int. Cl. G06F 17/60

(52) U.S. Cl. 705/4

(57) ABSTRACT

A method of providing insurance for an intellectual property (IP) asset comprising the steps of: identifying the IP asset for which insurance is desired; identifying one or more risks associated with the IP asset; identifying and gathering relevant risk data and financial data related to the IP asset and the one or more risks; computing a valuation for each risk; computing a total risk value; constructing an IP insurance policy for the asset related to at least one of the identified risks, the policy comprising a scope of coverage including a monetary coverage amount for a length of time in consideration for a premium to be charged; issuing or underwriting the IP insurance policy; and collecting premiums.

### CROSS-REFERENCE TO RELATED APPLICATIONS

This application claims priority of United States Provisional Application Serial No. 60/242,307, filed on Oct. 20, 2000, incorporated herein by reference.

### TECHNICAL FIELD

This invention relates to the fields of insurance and intellectual property, and more particularly to the provision of insurance protection for intellectual property assets.

### BACKGROUND OF THE INVENTION

Increasingly, Intellectual Property (IP) assets are becoming more important and valuable to business. They are unique assets that have heretofore been classified as intangible, but are now being recognized as having a more tangible or real value. The use of insurance in the business world and in the private lives of individuals is well-known for protecting against various risks, from product liability and general liability in the business world, to fire, life, and automobile insurance in both the private and business sectors. There are also many risks associated with IP asset transactions, however, which have not traditionally been protected by insurance coverage.

### SUMMARY OF THE INVENTION

In accordance with this invention, there is provided a method of providing insurance for an intellectual property asset. The method comprises the steps of:

(a) identifying the IP asset for which insurance is desired;

(b) identifying one or more risks associated with the IP asset;

(c) identifying and gathering relevant risk data and financial data related to the IP asset and the one or more risks;

(d) computing a valuation for each risk;

(e) computing a total risk value;

(f) constructing an IP insurance policy for the asset related to at least one of the risks identified in step (b), the policy comprising a scope of coverage including a monetary coverage amount for a length of time in consideration for a premium to be charged;

(g) issuing or underwriting the IP insurance policy; and

(h) collecting the premium.

After issuing or underwriting the insurance policy, the method may further comprise syndicating the insurance policy. The method may also further comprise the steps of: (i) receiving one or more claims related to the insurance policy; and (j) investigating said one or more claims. Optionally, after step (j), the method may comprise making a payment related to the one or more claims.

### BRIEF DESCRIPTION OF DRAWINGS

FIG. 1 is a flowchart of an exemplary method of the present invention.

### DESCRIPTION OF INVENTION

The invention will next be illustrated with reference to the figure wherein similar numbers indicate the same elements in all figures. The figure is intended to be illustrative rather than limiting and are included herewith to facilitate the explanation of the apparatus of the present invention.

The present invention comprises a method of providing insurance to protect the various parties engaging in IP asset transactions from one or more risks. Preferably such insurance protects against a complete range of IP risk exposures. The goals of the present method are to protect, manage and control the risk in an IP transaction by quantifying the risk and allowing for the reduction of the risk.

This method can be used to insure any party who has exposure to IP risks or is involved in an IP transaction, including but not limited to: owners, lenders, purchasers, creditors, sellers, accountants, licensors and licensees, attorneys, or underwriters. Such IP transactions may involve one or more IP assets, each having a corresponding status. The types of IP assets include but are not limited to: patents, copyrights, trade secrets, trademarks, trade names, and domain names. Each type of asset may also have one or more subtypes.

The subtypes for a United States patent, for example, include, but are not limited to, provisional and non-provisional patents, and utility, design, and plant patents. The status for a patent may include, but is not limited to, whether it is pending, allowed, issued, reissued, under reexamination, or abandoned. Such patents may relate to any type of patentable subject matter, including but not limited to, articles of manufacture, compositions of matter, processes, methods such as business methods or computer software, and the like.

The trademark subtypes may include common law marks, state registered marks, and federally registered marks, and may be further broken down into trademarks, service marks, certification marks, collective marks, and membership marks. For trademarks, the status may include, but is not limited to, whether the mark is registered or pending. The sub-status of a pending trademark may include whether the application is based on actual use or an intent-to-use. The trademark may relate to any type of goods or services in connection with which the mark is used.

The status for a copyright may be registered or not registered. Copyright subtypes may include any type of work protected under copyright law, including but not limited to, literary works, performing arts, sound recordings, visual arts, serials (newspapers, journals, magazines, and the like), architectural works, and multimedia works.

Trade secrets may relate to any of the patentable subject matters listed above, or may relate to any proprietary information of a company or individual, such as customer lists or other databases.

Each of the above types of IP assets may further be broken down by geographic region, such as the country or group of countries (such as the European Community, for example) in which the asset is registered, granted, pending, or the like.

The method of this invention can be used to insure any type of risk associated with any type of IP asset. The process can be used to self-insure, or by a third party insurer, underwriter or syndicator. The process can be used to provide any amount of monetary coverage for any time period of IP risk, such as a predetermined number of days, months, or years, or for the life of the IP asset.

The method of providing such insurance may involve the unique feature of conducting an Intellectual Property Audit (IP Audit) to ensure the integrity of the insurance. Such an IP audit is preferably conducted by an independent third party. The IP Audit may comprise the method described in the U.S. Application titled METHOD FOR AUDITING INTELLECTUAL PROPERTY, filed on Oct. 11, 2001, by the inventor of the present invention, claiming priority from provisional application 60/240,135, filed on Oct. 13, 2000, and incorporated herein by reference. Such an audit identifies all the relevant valuation factors for a given IP risk and all relevant data and statistics necessary to compute each valuation factor. The IP audit verifies the data and calculation used in one or more steps of the present method, and is primarily used to verify the accuracy of all data and computations for the valuation factors for a given IP risk.

The various types of IP risk or exposure fall into the following general categories: existence of the asset, ownership of the asset, strength of the asset, income attributable to the asset, expenses associated with the asset, litigation related to the asset, country-specific risks, loan collateral issues, valuation risks, and investment risks.

The general risk category relating to existence of the asset may have a number of subcategories, some IP asset specific. For example, for a patent, the validity of the patent may be an issue. Patent validity may be at risk as a result of any of a number of problems, including but not limited to, misjoinder of inventors, publication or commercialization of invention prior to the filing date of the patent, prior art not before the patent office during prosecution or later determined to be improperly considered by the patent office, inequitable conduct or fraud by the inventors or inventors' agents or attorneys, or unintentional abandonment due to missing a bar date, filing date, or maintenance fee payment. a trademark, the validity may be at risk because of prior use of the same or similar mark likely to cause confusion by another who has not abandoned such use, or as a result of fraud or inequitable conduct, failure to renew, failure to file a statement of use, failure to file an affidavit of use, and the like.

The validity of a copyright may be at risk, for example, if the person filing the copyright was not the owner or creator of the work, such as if the work was plagiarized.

The risk related to the existence of the asset may change depending on the status of the asset. For example, a patent or patent application or trademark or trademark application may be at any stage in its life cycle, including but not limited to: not yet filed, pending (as a provisional or non-provisional patent application or as an intent-to-use or use-based trademark application), allowed, issued, expired, or registered. At any point in the life cycle, the asset may have a remaining life, which may be renewable in the case of a trademark, for example, or non-renewable, such as in the case of a patent or copyright.

Under the general risk category of ownership, risks may arise as a result of improper title in the asset; encumbrances on the ownership, such as liens or claims by third parties; assignments of ownership; co-ownership or interests in the asset held by third parties; and theft (particularly with respect to trade secrets). Such ownership issues may be raised in litigation and may further be related to validity questions.

The strength of an IP asset may be at risk for any of a number of reasons, which may be asset-specific. For example, the claims of a patent may not be as strong as originally believed because, for instance, the claims are so narrow that they can be circumvented by non-infringing substitutes, or the claims are so broad as to be invalid in light of the prior art. The claims may conflict with claims of pending applications, provoking an interference, or with issued patents, potentially resulting in an infringement action. The degree to which the asset's strength is at risk may be directly related to the adequacy and completeness of any search, such as a patentability or trademark search, performed as part of the process of securing the asset.

The income related to an asset may be the result of a license. In such case, risks may arise because of the license length or term and the corresponding royalty stream associated with the license. Such stream may be increasing, decreasing, or may discontinue altogether. The income associated with the asset may be greatly affected by competition in the marketplace, by available substitutes for the products or services associated with the IP asset, or by circumvention of the IP asset by competitors (such as by designing around patent claims). The risks associated with the asset may be dependent upon the typical market life in the particular field to which the asset relates. For example, in a highly innovative field, the market life of a particular asset may be greatly limited by the pace of technology improvements.

The expenses associated with an asset may create risks because of unexpected development costs associated with the asset, higher than expected filing, prosecution and maintenance costs associated with the asset, or unforseen litigation expenses.

Litigation itself constitutes a general category of risk, as IP assets may typically be a very lucrative key to market share, and thus fraught with litigation. Litigation may be initiated by the IP asset owner (the insured) against infringers or producers of knockoffs of the owner's asset, or by third parties against insured, alleging infringement by the insured of some IP asset owned by the third party. Litigation may also relate to theft of trade secrets; fraud or breach by, or bankruptcy of, a licensor or licensee; as well as ownership, title, or validity issues.

County-specific risks may include, for example, destabilization of the government under which the IP asset was registered or issued, or risks associated with enforcement of IP assets in specific countries. Under the general category of loan collateral risks are included risks related to default and bankruptcy, for example in situations where the IP asset is used as collateral. Risks associated with valuation of the IP asset, as referred to herein, relate to situations where the initial IP asset valuation used for making some decision may have been incorrect. Such risks may relate to an attorney's opinion, such as a patentability opinion, patent non-infringement opinion, or clearance opinion for use and registerability of a trademark. Such risks may further relate to the opinions of accountants, underwriters, actuary, analysts such as CFAs (chartered financial analysts), and investment bankers, such as opinions related to an IPO (initial public offering).

An important part of the claimed method is determining a proper valuation for the IP asset. To do so, relevant financial data is identified and verified for each IP asset. The financial data may include the total net liabilities, taking into account expenses such as filing fees, issue fees, registration fees, maintenance fees or other annuities due, license fees, royalties owed, liens, encumberances, legal expenses, awards or settlements owed or paid, taxes, and any other expenses related to the asset. The financial data also includes the total net income, such as from royalties and licensing revenue, litigation or settlement awards, proceeds from sale of the assets, cash advances using the asset as collateral, and any other income attributable to the IP asset. The financial data may be apportioned according to the percentage of the asset owned or controlled.

The financial data may further include estimated net after tax income associated with the intellectual property status of the asset (revenue after subtraction of all manufacturing and overhead costs, after taxes). For example, if the asset enjoys a monopoly position due to its patent protection, all of the revenue generated by the product line associated with the asset may be attributable to the asset, because whomever owns the IP asset has the right to exclude all others from making the same product. On the other hand, if there is competition in the marketplace, and the patent protection is responsible for only a certain percentage of the market share of the product, only a portion of the net income may be actually attributable to the asset. The extent to which such data is included in the analysis may be a factor of the type of valuation being performed (see below) as well as a factor of how conservative an analysis is desired.

The valuation formula into which the financial data for each IP asset is input may be largely dependent upon the status of the IP asset. For example, if the status is abandoned, lapsed, or expired, there may be little or no financial value remaining in the asset, and the value may be discounted accordingly to take into account its status. The number of years remaining until expiration of the IP asset, particularly for patents and copyrights, may therefore be a critical figure in the analysis. The valuation formula may also be industry or country dependent. For example, in a technology field such as computer technology, the projected value of the asset may likely be less toward the end of the patent term, because the rapid pace of technological advancement may be likely to render the patent obsolete before the end of its term. Assets in certain countries or geographic regions known for intellectual property piracy and poor enforcement may be valued less than the same type of asset in a country with a better historical enforcement track record.

Thus, the factors that affect valuation may include but are not limited to: the existence and status of the asset, the validity of the asset, the number assets owned or controlled in a particular area, the royalty or other income stream associated with the asset, licenses and potential licenses, competition, royalty rates, potential for circumvention of the asset, strength of the asset, ownership of the asset including liens and encumbrances on the asset, expenses related to the asset, litigation related to the asset, the presence of infringers, potential claims of infringement by the asset owner, and the life of the asset, including the term of the asset as well as the life-cycle for assets in the corresponding market.

The valuation formula may also be dependent upon the type of value being computed. For example, it may be desired to compute a net present value or an estimated future market value of the asset. The value may be a purchase or sale value, a donation, gift or charity value, a tax value, a book or cost value, or a collateral, loan, or license value. The formulae for calculating each value may differ, as is generally known in the art. Certain formulae may be developed specifically for taking into account the various factors and uncertainties inherent in intellectual property valuations. Various methods for intellectual property valuation have been documented in the art, and portions of any or all of such methods may be pertinent for use with the method of this invention. Once the valuation formula has been chosen, a tangible valuation for each IP asset is computed and verified using the chosen formula.

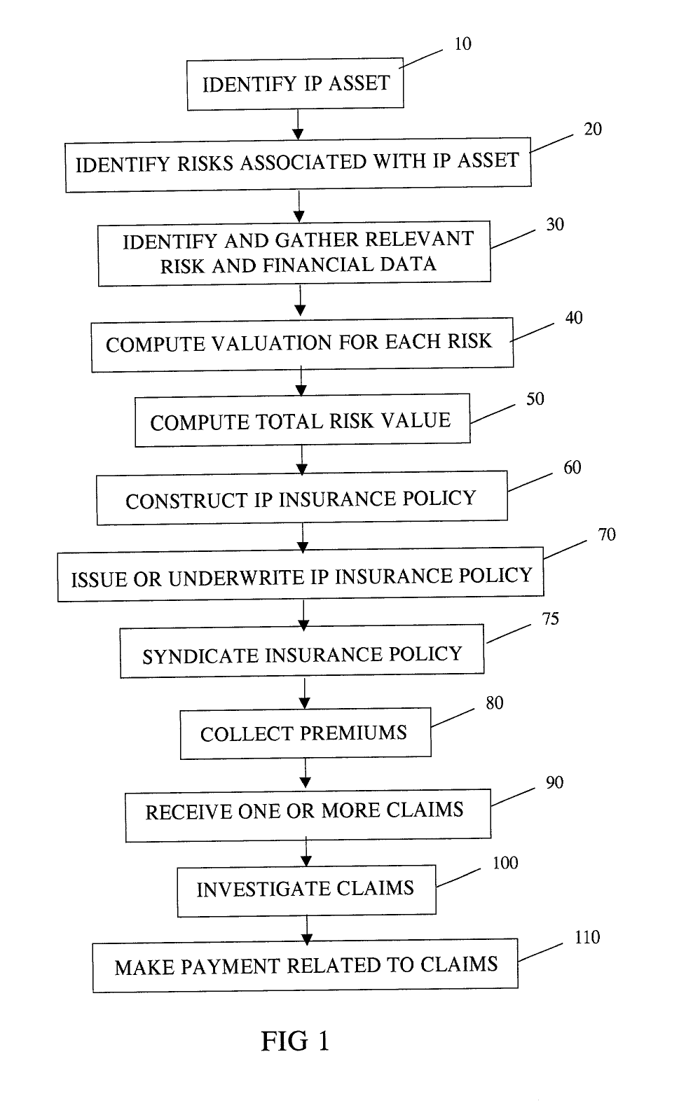

Referring now to the flowchart of FIG. 1, showing an exemplary method of providing insurance for an intellectual property asset, the method generally comprises numerous steps. First, subject to a request from or soliciation of a potential insured, an IP asset is identified for which insurance is desired, as shown in step 10. Next, in step 20, one or more risks associated with the IP asset is identified, such as one of the risks identified above. In step 30, relevant risk data and financial data related to the IP asset and the one or more risks is then identified and gathered as described above, from which a valuation for each risk is computed in step 40. In step 50, a total risk value is computed by summing the various risk valuations computed in step 40. Steps 40 and/or 50 may comprise actuarial analysis to value the individual and total risks.

Then, in step 60, an IP insurance policy for the IP asset related to at least one of the risks identified in step (b) is constructed. Constructing the policy typically comprises determining the scope and type of risk to be insured, including determining the monetary amounts of insurance to be provided, the length of time the insurance is to be provided, and the premium to be charged. Thus, the policy comprises a scope of coverage including a monetary coverage amount for a length of time in consideration for a premium to be charged. For example, an exemplary policy in accordance with this invention may cover the risk of a patent becoming invalid up to a one time lump-sum payment of $10 million, for the life of the patent, and may cost the insured an annual premium of $100,000.

The IP insurance policy is then issued or underwritten in step 70. It should be noted that this method may be practiced by an agent who issues the policy, and insurance company who underwrites the IP insurance policy, or, optionally, an insurance syndicate who reinsures the underwriter. Thus, the method may further comprise syndicating the insurance policy, as shown in step 75.

Finally, in step 80, the method comprises collecting the premiums. After issuing or underwriting the insurance policy, the method may optionally comprise the steps of receiving one or more claims related to the insurance policy, as shown in step 90, and investigating the one or more claims, in step 100. After the claim is investigated and substantiated, the method may comprise making a payment related to the one or more claims, in step 110.

As discussed herein, the method may further comprise conducting an IP Audit of the IP asset to independently verify the IP asset valuation. The audit, as described completely in the aforementioned provisional patent application incorporated herein by reference, comprises the steps of:

(a) identifying and classifying the intellectual property asset;

(b) inspecting documentation related to the intellectual property asset;

(c) determining validity of the intellectual property asset;

(d) identifying and verifying relevant financial data for the intellectual property asset;

(e) identifying and verifying a proper tangible valuation formula for the intellectual property asset;

(f) computing and verifying a tangible valuation for the intellectual property asset using said formula;

(g) preparing an income statement reflecting revenue and expenses associated with the intellectual property asset;

(h) preparing a balance sheet reflecting the intellectual property asset and corresponding valuation; and

(i) issuing an opinion certifying that the intellectual property asset and corresponding tangible value is fairly stated in accordance with generally accepted accounting principles.

Those skilled in the art having the benefit of the teachings of the present invention as hereinabove set forth, can effect numerous modifications thereto. These modifications are to be construed as being encompassed within the scope of the present invention as set forth in the appended claims.

What is claimed:

1. A method of providing insurance for an intellectual property (IP) asset, the method comprising the steps of:
(a) identifying the IP asset for which insurance is desired;
(b) identifying one or more risks associated with the IP asset;
(c) identifying and gathering relevant risk data and financial data related to the IP asset and the one or more risks;
(d) computing a valuation for each risk;
(e) computing a total risk value;
(f) constructing an IP insurance policy for the asset related to at least one of the risks identified in step (b), the policy comprising a scope of coverage including a monetary coverage amount for a length of time in consideration for a premium to be charged;
(g) issuing or underwriting the IP insurance policy; and
(h) collecting the premium.

2. The method of claim 1 further comprising, after issuing or underwriting the insurance policy, syndicating the insurance policy.

3. The method of claim 1 further comprising the steps of:
(i) receiving one or more claims related to the insurance policy; and
(j) investigating said one or more claims.

4. The method of claim 3 further comprising after step (j), making a payment related to the one or more claims.

5. The method of claim 1 further comprising conducting an intellectual property audit of the IP asset, the audit comprising the steps of:
(a) identifying and classifying the intellectual property asset;
(b) inspecting documentation related to the intellectual property asset;
(c) determining validity of the intellectual property asset;
(d) identifying and verifying relevant financial data for the intellectual property asset;
(e) identifying and verifying a proper tangible valuation formula for the intellectual property asset;
(f) computing and verifying a tangible valuation for the intellectual property asset using said formula;
(g) preparing an income statement reflecting revenue and expenses associated with the intellectual property asset;
(h) preparing a balance sheet reflecting the intellectual property asset and corresponding valuation; and
(i) issuing an opinion certifying that the intellectual property asset and corresponding tangible value is fairly stated in accordance with generally accepted accounting principles.
